(19) United States
(12) Patent Application Publication
(10) Pub. No.: US 2003/0093811 A1
(43) Pub. Date: May 15, 2003

(54) Bandwidth directional coupler

(75) Inventor: David M. Kaufman, Lansdale, PA (US)

Correspondence Address: MAYER, FORTKORT & WILLIAMS, PC, 251 NORTH AVENUE WEST, 2ND FLOOR, WESTFIELD, NJ, 07090, US

(73) Assignee: General Instrument Corporation

(21) Appl. No.: 10/055,526

(22) Filed: Nov. 13, 2001

(51) Int. Cl. H04N 7/173; H04N 7/16

(52) U.S. Cl. 725/128; 725/127; 725/149

(57) ABSTRACT

A directional coupler system includes an input diplex filter for splitting an input signal into a high band signal and a low band signal, a high band directional coupler for which the high band signal is coupled to an input of the high band directional coupler, a low band directional coupler for which the low band signal is coupled to an input of the low band directional coupler, a tap diplex filter coupled to a tap of each of the high band directional coupler and low band directional coupler and an output diplex filter for receiving and combining a high band signal output from the high band directional coupler and a low band signal output from the low band directional coupler. The coupler system improves the bandwidth in a coaxial cable transmission system

### FIELD OF THE INVENTION

The present invention relates generally to improving bandwidth in a coaxial cable transmission system, and more particularly, to an improved bandwidth directional coupler.

### BACKGROUND OF THE INVENTION

As illustrated in FIG. 1, a hybrid Fiber-Coax (HFC) cable television (CATV) system typically employs fiber optics, having an extremely wide bandwidth on the order of 1 GHz, from the headend (or hub) to the nodes (typically covering, for example, 5-7 miles). More specifically, many fiber-optic cables emanate from the headend, and feeds analog sub-networks. At the interface between the fiber and the coax is a fiber/coax node.

At the fiber/coax node, the fiber transmission medium terminates at a fiber/cable interface and is converted to coaxial cable (typically covering, for example, a mile to the home). The coax will either feed an analog distribution network that first includes a trunk amplifier, or not, if there are enough nodes in the system. As shown, the analog distribution network consists of bridger amplifiers and line extenders in that order, and with varying amounts of cable in between the amplifiers, as system requirements dictate. The line extender, being the final amplifier in the network, drives a series of splitters, followed by directional couplers, known as “taps”, which couples to a feeder or drop cable that services the customer premises (usually less than 100 ft to the home).

The last mile of “coaxial cable”, including line extenders, splitters, etc. may operate up to 1 GHz. However, the amplifiers required typically can not operate at 1 GHz, thereby causing a bottleneck at the node.

Essentially, the directional coupler (or “tap”) is used to couple a fraction of the energy or signal from the main signal line to the load. FIG. 2 is a schematic illustrating the basic components of a typical directional coupler. As shown, port 1 is the ‘input’, port 2 the ‘output’, and port 3 the ‘tap’ port. The current from port 1 is sampled at transformer T1 and the voltage on port 2 is sampled at transformer T2. Because the secondary current and voltage are in phase, the secondaries of transformers T1 and T2 are combined so that some of the power flowing from port 1 to port 2 is diverted to port 3 (the ‘tap’). The performance of the directional coupler is based on the construction of the transformers used in the coupler (the core materials, the dimensions of the transformers, including the length of wire on the windings, etc.) However, the bandwidth spectrum from 5 MHz to 1,000 MHz is available from conventional directional coupler technology.

Various problems arise in attempting to increase the bandwidth of taps by utilizing improved ferrite transformer cores. For example, to obtain good performance at high frequencies, the dimensions of the transformers must remain small compared with a wavelength, i.e. with small, high permeability cores and with fine gauge wire, which however limits the power-handling capability. In addition, the problem of keeping the insertion loss of the coupler small arises especially at the higher range of operation, where the coupler tends to have increased insertion loss due to increased core losses, and leakage inductance. The result is non-flatness over frequency both in the through path as well as in the tap or coupled path. Also, the isolation over frequency degrades, which is important in order to keep reflections low on the cable, which might otherwise cause ghosting on the picture. Finally, a full bandwidth tap needs to have a power passing choke over the whole range of frequencies, which makes the design of a power passing choke more difficult.

The present invention is therefore directed to providing a cost-effective improved bandwidth directional coupler that implements a high/low split filter that therefore allows for a power passing choke over only the lower band of operation, thereby making the design of the power passing choke easier and realizable.

### SUMMARY OF THE INVENTION

According to the invention, a directional coupler system is introduced having an input diplex filter for splitting an input signal into a high band signal and a low band signal, the high band signal coupled to an input of a high band directional coupler, and the low band signal coupled to an input of a low band directional coupler, a tap diplex filter coupled to a tap of each of the high band directional coupler and low band directional coupler and an output diplex filter receiving and combining a high band signal output from the high band directional coupler and a low band signal output from the low band directional coupler.

In a number of particular embodiments, the high band directional coupler has a one octave bandwidth, the high band signal is operated from 1200-2400 MHz and the low band signal is operated from 5-1000 MHz.

The high band directional coupler may utilize stripline or microstrip technology and the low band directional coupler may use ferrite transformer technology.

In yet a further embodiment, each of the input diplex filter, tap diplex filter and output diplex filter are lumped component bandsplitting filters.

### BRIEF DESCRIPTION OF THE DRAWINGS

The above-mentioned and other objects, features and advantages of the present invention will become more apparent from the following detailed description when taken in conjunction with the accompanying drawings, wherein:

FIG. 1 depicts the basic elements of a hybrid fiber-coax transport system.

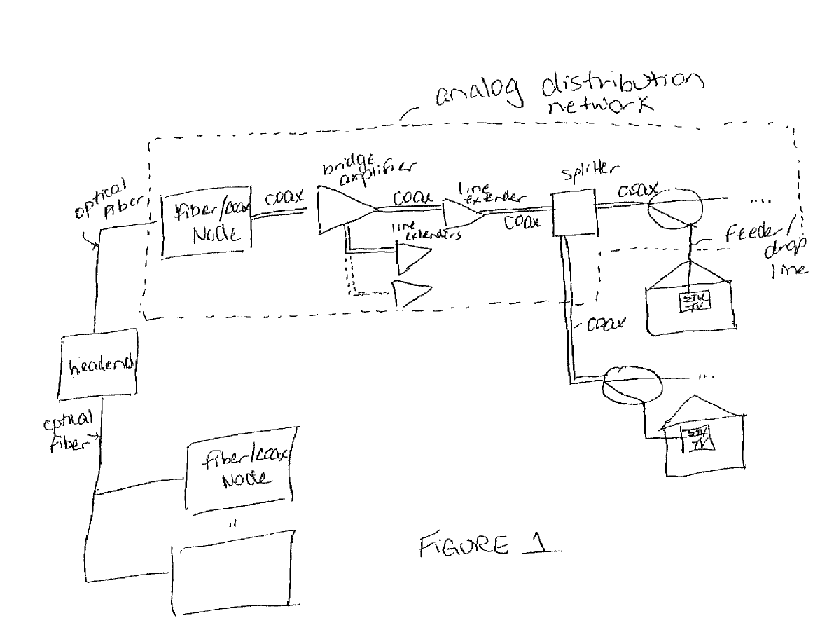

FIG. 2 is a schematic illustrating the basic components of a typical directional coupler.

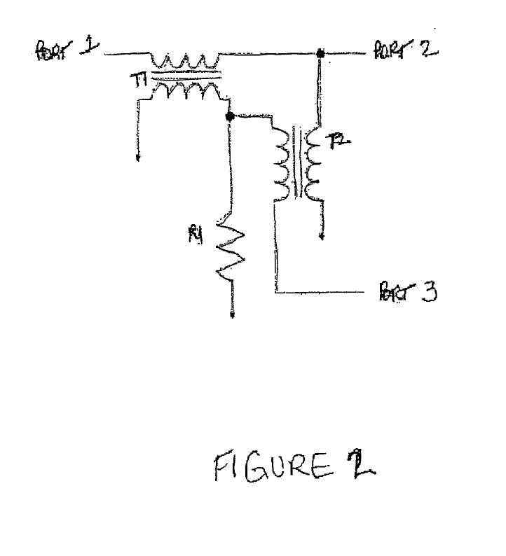

FIG. 3 depicts a simplified diagram of an improved bandwidth directional coupler in accordance with the invention.

FIG. 4 depicts an amplifier station implementing the band splitting scheme in accordance with the present invention.

FIG. 5 depicts an alternate typical amplifier station implementing the band splitting scheme in accordance with the present invention.

### DETAILED DESCRIPTION

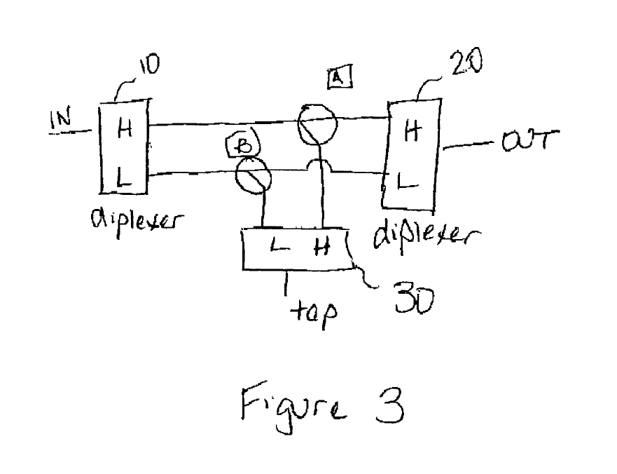

The basic elements of a proposed bandwidth directional coupler are shown in FIG. 3. As illustrated, a single directional coupler is constructed from two directional couplers in a band splitting scheme. In a preferred embodiment of the invention, the high band is operated from 1200-2400 MHz (1 octave bandwidth) and the low band operated from 5-1000 MHz. The low band directional coupler may use conventional ferrite transformer technology capable of up to 1000 MHz and the high band directional coupler may use microstrip or stripline technology. In addition, a preferred embodiment of the invention uses lumped component bandsplitting filters, which are desirable from several points of view. First, the alternative to lumped component bandsplitting filters, a transmission line filter, is not easily realizable at the expected range of operation, 5-1000 MHz (low split) and 1200-2400 MHz high split). Second, transmission line filters can have re-entrant responses, making them un-useable over broad bands of operation. Re-entrant responses are non-ideal in that the filter loss increases in magnitude where it should be decreasing as frequency goes up.

As shown in FIG. 3, a diplex filter 10 receives an input signal that is filtered into high pass and low pass signals. The high pass signal is received at the input of directional coupler A and the low pass signal is received at the input of directional coupler B. Each of the directional couplers' tap legs is output at tap 30. The high band signal is output from at the high output of diplexer 20 and the low band signal at the low output.

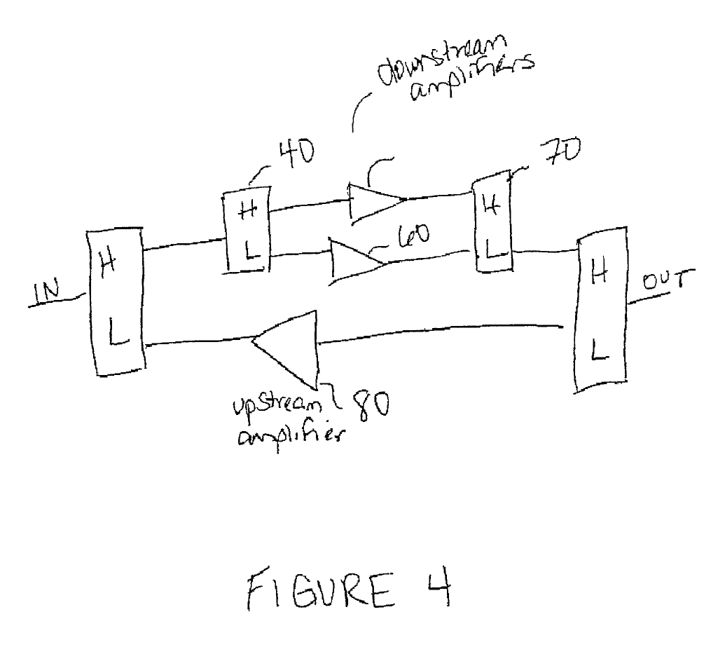

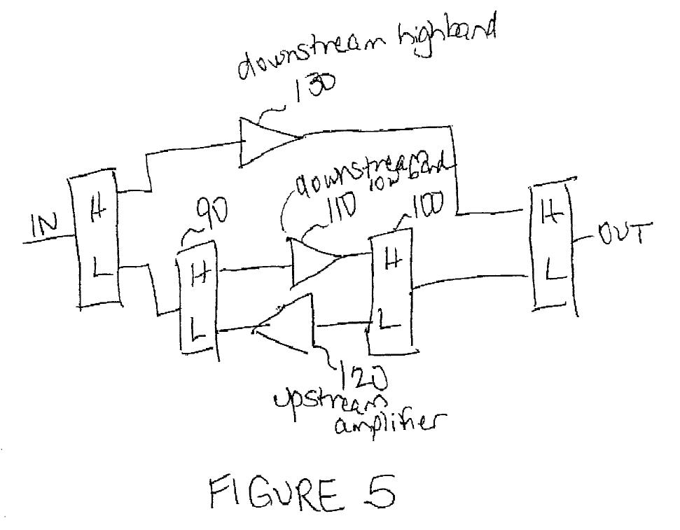

Exemplary amplifier stations are shown in FIG. 4 and FIG. 5. The station shown in FIG. 4 illustrates an amplifier station which utilizes two additional diplexers for the downstream signal, namely, 40 and 70, with two amplifiers between the two diplexers—amplifier 50, for the downstream high band signal and amplifier 60, for the downstream low band signal. One upstream amplifier 80 amplifies the upstream signal (typically 5-42 MHz).

The station shown in FIG. 5 illustrates an alternative station that utilizes two additional diplexers, 90 and 100, with two amplifiers between the two diplexers—amplifier 110, for the downstream low band signal, and amplifier 120, for the upstream signal, respectively. The downstream high band signal is amplified through amplifier 130 as shown.

There are many advantages to operating a feeder or line extender in a high/low split mode. Specifically, by operating separate high band and low band amplifiers, and operating the high band over one octave of bandwidth only, composite second order products of the high band amplifier are contained out of its band and are eliminated by a filter. This results in improved distortion requirements for the high band amplifier.

The above describes an approach to improving the bandwidth of a directional coupler for coaxial cable transmission systems without resorting to attempts to improve ferrite transformer cores. The approach uniquely constructs a single directional coupler from two directional couplers in a band splitting scheme and uses well-known technology for the low band directional coupler and microstrip or stripline technology for the high band directional coupler. The individual components are known and widely available. The technique is applicable to any hybrid fiber/coax architecture.

Although various embodiments are specifically illustrated and described herein, it will be appreciated that modifications and variations of the invention are covered by the above teachings and are within the purview of the appended claims without departing from the spirit and intended scope of the invention. For example, by substituting power splitters for the directional couplers, the invention could be used as a 3 dB power splitter as well (power is equally divided between ports 2 and 3, one half of the power appearing on each output—thus, the loss of the splitter from the input port 1 to either output must be 10 log(½)=3.0 dB). Furthermore, this exemplary modification should not be interpreted to limit the modifications and variations of the invention covered by the claims but are merely illustrative of possible variations.

What is claimed is:

1. A directional coupler system comprising:
an input diplex filter for splitting an input signal into a high band signal and a low band signal;
a high band directional coupler, wherein the high band signal is coupled to an input of said high band directional coupler;
a low band directional coupler, wherein the low band signal is coupled to an input of said low band directional coupler;
a tap diplex filter coupled to a tap of each of said high band directional coupler and said low band directional coupler; and
an output diplex filter for receiving and combining a high band signal output from said high band directional coupler and a low band signal output from said low band directional coupler.

2. The coupler system of claim 1, wherein said high band directional coupler has a one octave bandwidth.

3. The coupler system of claim 2, wherein the high band signal is operated from 1200-2400 MHz.

4. The coupler system of claim 2 wherein said high band directional coupler is stripline or microstrip technology.

5. The coupler system of claim 1 wherein said low band directional coupler is ferrite transformer technology.

6. The coupler system of claim 1, wherein the low band signal is operated from 5-1000 MHz.

7. The coupler system of claim 1, wherein each of said input diplex filter, said tap diplex filter and said output diplex filter are lumped component bandsplitting filters.

8. An improved wideband bandwidth directional coupler comprising:
a first directional coupler;
a second directional coupler, said first and second couplers arranged in a band splitting scheme;
first splitting means for splitting an input signal into a high band signal and a low band signal, wherein the high band signal is input to said first directional coupler and the low band signal is input to said second directional coupler;
second splitting means for receiving a high band signal output from said first directional coupler and a low band signal output from said second directional coupler; and
a tap for receiving a signal from each of a tap port of said first directional coupler and said second directional coupler.

9. The coupler of claim 8, wherein said first directional coupler has a one octave bandwidth.

10. The coupler system of claim 9, wherein the high band signal is operated from 1200-2400 MHz.

11. The coupler system of claim 9 wherein said first directional coupler is stripline or microstrip technology.

12. The coupler system of claim 8 wherein said second directional coupler is ferrite transformer technology.

13. The coupler system of claim 8, wherein the low band signal is operated from 5-1000 MHz.

14. The coupler system of claim 8, wherein each of said first splitting means, second splitting means and tap are lumped component bandsplitting filters.

15. A method for improving the bandwidth of a coaxial cable transmission system by providing an improved bandwidth directional coupler that implements a high/low split filter, the method comprising the steps of:
splitting an input signal into a high band signal and a low band signal;
coupling the high band signal to the input of a high band directional coupler and the low band signal to the input of a low band directional coupler;
coupling a tap diplex filter to a tap of each of the high band directional coupler and the low band directional coupler; and
receiving and combining a high band signal output from the high band directional coupler and a low band signal output from the low band directional coupler.

16. The method of claim 15, wherein the high band signal is operated from 1200-2400 MHz.

17. The method of claim 15 wherein the high band directional coupler is stripline or microstrip technology.

18. The coupler system of claim 15 wherein the low band directional coupler is ferrite transformer technology.

19. The method of claim 15, wherein the low band signal is operated from 5-1000 MHz.
